(19) United States
(12) Patent Application Publication
(10) Pub. No.: US 2015/0116347 A1
(43) Pub. Date: Apr. 30, 2015

(54) ELECTRONIC DEVICE AND METHOD FOR OUTPUTTING DATA IN ELECTRONIC DEVICE

(71) Applicant: Samsung Electronics Co., Ltd., Gyeonggi-do (KR)

(72) Inventors: Seul-A KIM, Seoul (KR); Sung-Jin PARK, Seoul (KR)

(21) Appl. No.: 14/311,744

(22) Filed: Jun. 23, 2014

(30) Foreign Application Priority Data
Oct. 24, 2013 (KR) 10-2013-0127071

(51) Int. Cl. G06F 1/16

(52) U.S. Cl. CPC G06F 1/1677; G06F 1/1603; G06F 2200/1634
USPC 345/619

(57) ABSTRACT

An electronic device includes an external cover connector connected to a display unit of an external cover; and a controller configured to change first information of data selected to be displayed on the display unit of the external cover to second information for the display unit of the external cover; and output the data with the second information to the display unit of the external cover while the external cover attached to the electronic device is closed over the electronic device.

### CROSS-REFERENCE TO RELATED APPLICATION(S)

This application claims the benefit under 35 U.S.C. §119(a) of a Korean patent application filed on Oct. 24, 2013 in the Korean Intellectual Property Office and assigned Serial No. 10-2013-0127071, the entire disclosure of which is incorporated hereby incorporated by reference.

### TECHNICAL FIELD

The present disclosure relates to an electronic device and method for outputting data in the electronic device. More particularly, the present disclosure relates to an electronic device and method for outputting data in the electronic device, which enables data of the electronic device to be displayed on a display unit of an external cover attached to the electronic device.

### BACKGROUND

These days, external covers for electronic devices are becoming one of the most popular accessories among people who use the electronic devices.

The external cover is designed to protect the electronic device and thus is made of plastics, leather, or anything appropriate for protection. If the external cover is made of leather, cloth, or rubber, it needs to remain as thick as to sufficiently absorb external shock and pressure.

However, the external protection cover usually hides the screen of the electronic device while it is closed over the electronic device. Accordingly, whenever the user wants to check received messages or current status of the electronic device while the cover is closed, the user has to open the external cover first, which causes inconvenience to the user.

### SUMMARY

The present disclosure provides an electronic device and method for displaying data in the electronic device, which enables data of the electronic device optimized for a display unit of an external cover attached to the electronic device to be outputted onto the display unit.

In accordance with an aspect of the present disclosure, provided is an electronic device including an external cover connector connected to a display unit of an external cover; and a controller configured to change first information of data selected to be displayed on the display unit of the external cover to second information for the display unit of the external cover; and output the data with the second information to the display unit of the external cover while the external cover attached to the electronic device is closed over the electronic device.

In accordance with another aspect of the present disclosure, provided is a method for outputting data in an electronic device, the method including: changing first information of data selected to be displayed on a display unit of an external cover attached to the electronic device to second information for the display unit of the external cover; and outputting data with the second information to the display unit of the external cover if the external cover is closed over the electronic device.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other features and advantages of the present disclosure will become more apparent by describing in detail exemplary embodiments thereof with reference to the attached drawings in which:

FIG. 1 illustrates an electronic device and an external cover equipped with a display unit, which may be attached to the electronic device, according to an embodiment of the present disclosure;

FIG. 2 is a block diagram illustrating an electronic device, according to an embodiment of the present disclosure;

FIG. 3 is flowchart illustrating operations of setting data for output onto a display unit of an external cover attached to an electronic device and outputting the data onto the display unit while the external cover is closed, according to an embodiment of the present disclosure;

FIG. 4A and FIG. 4B illustrate an electronic device setting a background screen for an external cover attached to the electronic device using the menu for settings, according to various embodiments of the present disclosure;

FIG. 5 illustrates how to set data of an electronic device for output onto a display unit of an external cover attached to the electronic device, according to various embodiments of the present disclosure;

FIG. 6 illustrates how to output data of an electronic device onto a display unit of an external cover attached to the electronic device while the external cover is closed, according to various embodiments of the present disclosure;

FIG. 7A and FIG. 7B are flowchart illustrating operations of outputting data onto a display unit of an external cover by changing the data to list data while the external cover attached to an electronic device is closed over the electronic device, according to various embodiments of the present disclosure;

FIG. 8 illustrates an electronic device outputting data onto a display unit of an external cover attached to the electronic device by converting the data to list data while the external cover is closed over the electronic device, according to various embodiments of the present disclosure;

FIG. 9 is flowchart illustrating operations of outputting data of an electronic device having an external cover attached thereto onto a display unit of the external cover by selecting a background screen user interface for external cover, according to various embodiments of the present disclosure;

FIG. 10 illustrates an electronic device providing a background screen user interface for an external cover attached to the electronic device, according to various embodiments of the present disclosure;

FIG. 11 is flowchart illustrating operations of handling an event that occurs while an external cover attached to an electronic device is closed over the electronic device, according to various embodiments of the present disclosure; and

FIG. 12A and FIG. 12B illustrate an electronic device handling an event that occurs while an external cover attached to the electronic device is closed over the electronic device, according to various embodiments of the present disclosure.

Throughout the drawings, like reference numerals will be understood to refer to like parts, components, and structures.

### DETAILED DESCRIPTION

The disclosure now will be described more fully hereinafter with reference to the accompanying drawings, in which illustrative embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure. Descriptions shall be understood as to include any and all combinations of one or more of the associated listed items when the items are described by using the conjunctive term “˜and/or˜,” or the like.

The terminology used herein is for the purpose of describing particular embodiments only and is not intended to be limiting of the disclosure.

It is to be understood that the singular forms “a,” “an,” and “the” include plural references unless the context clearly dictates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In various embodiments of the present disclosure, an electronic device comprises a portable terminal and a fixed terminal. The portable terminal is a mobile electronic device that is easily carried by humans, and may include video phones, cellular phones, smart phones, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, E-Books, portable computers (e.g., laptops, tablet PCs, etc.), or digital cameras. The fixed terminal may be a desktop personal computer (PC).

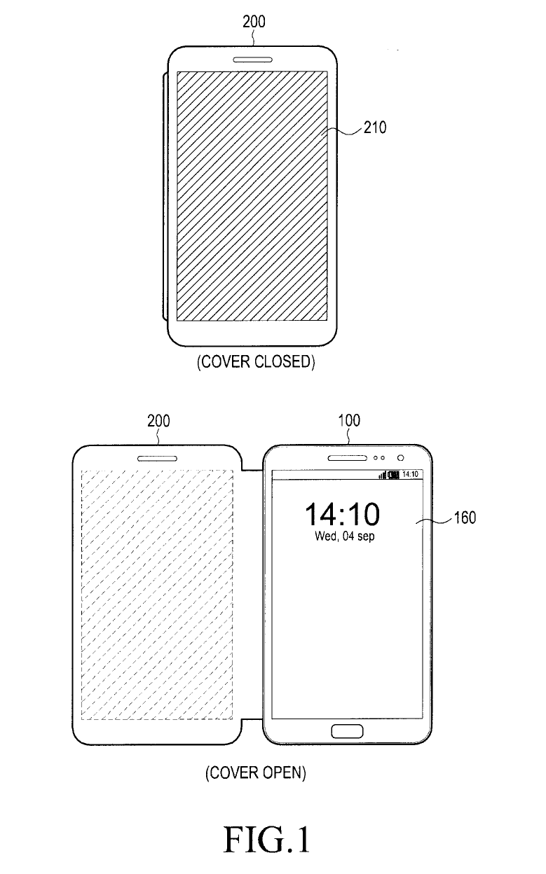

FIG. 1 illustrates an electronic device 100 and an external cover 200 equipped with a display unit 210, which may be attached to the electronic device 100, according to an embodiment of the present disclosure.

Referring to FIG. 1, upon detection of attachment of the external cover 200, the electronic device 100 may transmit power and data to the external cover 200 through a connection (not shown) included in the electronic device 100 to the external cover 200.

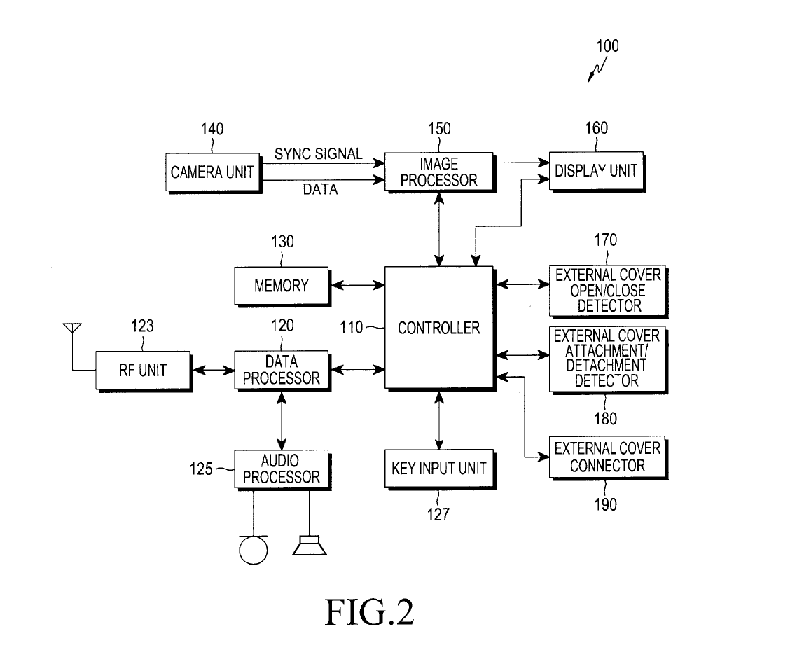

The data sent from the electronic device 100 to the external cover 200 may have data with second information, which is e.g., color information for display on the display unit 210 of the external cover 200. For example, the color information indicates mono color, and the data may be displayed in mono color on the display unit 210 of the external cover 200. Detailed configuration of the electronic device 100 will be described later in connection with FIG. 2.

The external cover equipped with the display unit 210 may be attached to the electronic device 100. The display unit 210 of the external cover uses a panel that is slim and impact-resistant which minimizes power consumption. For example, a reflective panel, such as an Electronic Paper Display (EPD) panel may be used as the display unit 210. The display unit 210 may be located on the exterior of the external cover 200, so that the display unit 210 is visible when the external cover 200 is closed over the display unit 160 of the electronic device 100.

When the external cover 200 is attached to the electronic device 100, it receives power and data from the electronic device 100 and may display the data on the display unit 210.

The display unit 210 may be implemented in the form of a touch screen, in which case upon a touch activity on the display unit 210, a function in response to the touch activity is performed and the result may be displayed on the display unit 210.

FIG. 2 illustrates a block diagram of the electronic device 100, according to various embodiments of the present disclosure.

Referring to FIG. 2, a Radio Frequency (RF) unit 123 performs a wireless communication function of the electronic device 100. The RF unit 123 includes an RF transmitter for up converting a frequency of a transmit signal and amplifying the transmit signal and an RF receiver for low-noise amplifying a received signal and down converting the frequency of the received signal. A data processor 120 may include a transmitter for encoding and modulating the transmit signal, and a receiver for demodulating and decoding the received signal. The data processor 120 may include a modem and a codec. The codec includes a data codec for processing e.g., packet data and an audio codec for processing an audio signal, such as voice. An audio processor 125 may play a received audio signal output from the audio codec of the data processor 120, or transmits an audio signal from a microphone to the audio codec of the data processor 120.

A key input unit 127 includes alphanumeric keys for inputting number and character information, and function keys for setting various functions.

A memory 130 may include any suitable type of volatile and non-volatile memory, such as a Random Access Memory (RAM), Read-Only Memory (ROM), Hard Drive (HD), Solid State Drive (SSD), flash memory, etc. A memory 130 may include program and data memories. The program memory may store programs to control general operations of the electronic device 100, and programs to control data originated from the electronic device 100 to be adapted to the display unit 210 of the external cover 200 e.g., by changing color information for the data to be displayed on the display unit 210. Also, the data memory may temporarily store data generated in the course of running the programs.

The memory 130 may store at least one background screen for external cover to be displayed on the display unit 210 of the external cover 200 in an embodiment of the present disclosure, and store data of the electronic device 100 that includes the second information, which is color information, for display on the display unit 210, the data with the second information being configured for each of the at least one background screen for external cover.

A controller 110 controls overall operations of the electronic device 100. The controller 110 may include any suitable type of processing circuitry, such as a processor (e.g., an x86-based processor, an ARM-based processor, etc.), a Field-Programmable Gate Array (FPGA), an Application-Specific Integrated Circuit (ASIC), etc.

In various embodiments of the present disclosure, upon selection of data to be displayed on the display unit 210 of the external cover 200, the controller 110 may change first information of the data to second information for display on the display unit 210, and output the data with the second information to the display unit 210 while the external cover 200 is closed.

If the external cover 200 attached to the electronic device 100 is opened, the controller 110 may determine whether a background screen for external cover is set in various embodiments of the present disclosure. If it is determined that the background screen for external cover is set and the external cover 200 is opened, the controller 110 may generate and display the at least one background screen for external cover on a display unit 160 of the electronic device 100. For display on the display unit 210 of the external cover, the controller 110 changes first information of the at least one data selected by the user to second information, and configure and display the at least one data with the second information to be data for the at least one background screen for external cover.

In various embodiments of the present disclosure, the first information may be color information for display on the display unit 160 of the electronic device 100, indicating various original colors of the data. The second information of the data may be color information for display on the display unit 210 of the external cover 200, indicating a color or colors that the display unit 210 supports. The second information may vary depending on the types of the display unit 210 of the external cover 200.

In various embodiments of the present disclosure, the electronic device 100 may store data with the first information indicating original color information and data with the second information indicating color for display on the display unit 210 of the external cover 200.

The controller 110 may create and display at least one background screen for external cover on the display unit 160 of the electronic device 100, and may display at least one of recommended data determined to be appropriate for display on the display unit 210 of the external cover 200.

If the external cover 200 is closed over the electronic device 100 after the at least one data with the second information is configured to be data for the at least one background screen for external cover, the controller 110 may display particular data among the at least one data with the second information configured for the at least one background screen for external cover on the display unit 210 of the external cover 200.

If a particular key is pressed while the external cover 200 is closed, the controller 110 may sequentially output the at least one data with the second information configured for the at least one background screen for external cover onto the display unit 210 of the external cover 200.

In various embodiments of the present disclosure, when the external cover 200 attached to the electronic device 100 is closed, the controller 110 may output at least one data with the second information configured for the at least one background screen for external cover onto the display unit 210 of the external cover 200.

If a particular key is pressed while data with the second information is outputted onto the display unit 210 of the external cover 210, the controller 110 may sequentially output the at least one data with the second information configured for the at least one background screen for external cover onto the display unit 210 of the external cover 200 in response to the inputs of the particular key.

In various embodiments of the present disclosure, the particular key refers to a key available while the external cover 200 is closed, which may be e.g., a volume key formed on the side of the electronic device 100 or a soft key that is displayed with the at least one data with the second information on the display unit 210 of the external cover 200. When the external cover 200 is opened while the display unit 210 of the external cover 200 displays the data with the second information, the controller 10 may display the background screen for external cover in which the data with the second information is configured, on the display unit 160 of the electronic device 100.

In various embodiments of the present disclosure, when the external cover 200 attached to the electronic device 100 is closed and if the data configured for a particular background screen for external cover among the at least one background screen for external cover is determined to be list format data that may be displayed in a list format, the controller 110 may output the list format data to the display unit 210 of the external cover 200.

When the external cover is opened again, the controller 110 may display the background screen for external cover, in which the data with the second information is configured, on the display unit 160 of the electronic device 100, and configure new data for the background screen for external cover by changing the data with the second information to the new data with the second information.

In various embodiments of the present disclosure, if a background screen User Interface (UI) for external cover is selected on the display unit 160 of the electronic device 100 having the external cover 200 attached thereto, the controller 110 may display the background screen for external cover in which data with the second information is configured on the display unit 160 of the electronic device 100. When the external cover 200 is closed while the display unit 160 of the electronic device 100 displays the background screen for external cover in which the data with the second information is configured, the controller 110 may output the background screen for external cover in which the data with the second information is configured onto the display unit 210 of the external cover 200. Furthermore, if a particular key is pressed while data with the second information is outputted onto the display unit 210 of the external cover 210, the controller 110 may sequentially output the at least one data with the second information configured for the at least one background screen for external cover onto the display unit 210 of the external cover 200.

In various embodiments of the present disclosure, if an event occurs while the data with the second information is displayed on the display unit 210 of the external cover 200 that is closed over the electronic device 100, the controller 110 may display the event on the display unit 210 of the external cover 200. After this, when the external cover 200 is opened, the controller 110 may run an application corresponding to the event and display the resultant content on the display unit 160 of the electronic device 160.

A camera unit 140 capturing an image includes a camera sensor for converting the captured image to analog electric signals, and a signal processor for converting analog electric signals to digital image data. The camera sensor is assumed to be a Charge-Coupled Device (CCD) or a Complementary Metal-Oxide Semiconductor (CMOS), and the signal processor may be implemented with a digital signal processor (DSP). The camera sensor and the signal processor may be integrated together, or may be implemented separately.

An image processor 150 performs image signal processing (ISP) for displaying image data output by the camera unit 140, and the ISP performs gamma correction, interpolation, spatial change, image effect, image scale, Auto White Balance (AWB), Auto Exposure (AE), Auto Focus (AF), and the like. The image processor 150 processes the image data in the frame unit and outputs image frame data to a size and characteristics of the display unit 160. The image processor 150 also includes an image codec for compressing the image frame data to be displayed on the display unit 160 in a predetermined compression method or for decompressing the pressed frame image data. The image codec may be a Joint Photographic Experts Group (JPEG) codec, a Moving Picture Experts Group (MPEG) 4 codec, or the like. The image processor 150 is assumed herein to have an On Screen Display (OSD) function, and may output OSD data to a displayed screen size under control of the controller 110.

The display unit 160 displays the image frame data output by the image processor 150 onto a screen and displays user data output by the controller 110. The display unit 160 may use a Liquid Crystal Display (LCD), in which case the display unit 160 may include an LCD controller, a memory for storing the image frame data, and an LCD display device. If implemented as a touchscreen, the LCD of the display unit 160 may serve as an input unit, in which case keys like the key input unit 127 may be displayed on the display unit 160.

As the display unit 160 is implemented as the touchscreen, the display unit 160 may be comprised of Touch Screen Panels (TSPs) having a plurality of sensor panels. The sensor panels may include a capacitive sensor panels that may recognize human being's touches and an electromagnetic sensor panels that may detect finer touches, e.g., which is made by a touch pen.

In various embodiments of the present disclosure, the display unit 160 may display a background screen for external cover and data with second information for display on the display unit 210 of the external cover 200, which is configured for the background screen for external cover.

An external cover open/close detector 170 may include a hall sensor (e.g., hall Integrated Circuit (IC) sensor), which may send the controller 110 an open/close signal depending on whether a magnet included in the external cover 200 attached to the electronic device 100 made a contact.

An external cover attachment/detachment detector 180 may include a sensor for detecting attachment or detachment of the external cover 200 to or from the electronic device 100, and may send the controller 110 a signal resulting from attachment or detachment of the external cover 200 to or from the electronic device 100.

An external cover connector 190 may deliver power and data with the second information to the display unit 210 of the external cover 200 attached to the electronic device 100.

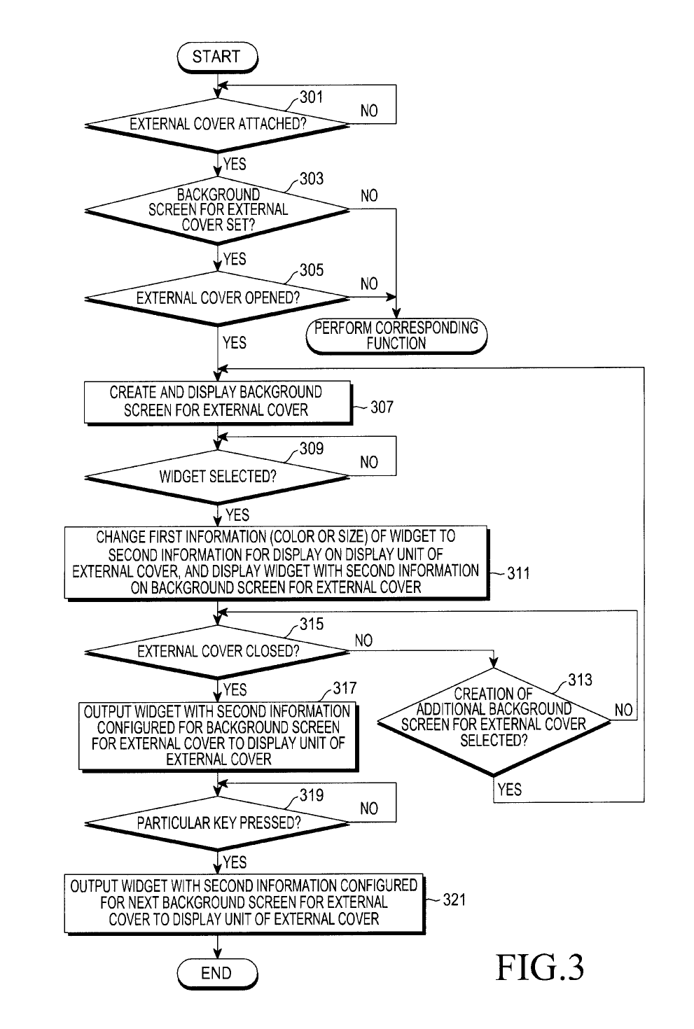

Operations of outputting data of the electronic device 100 to the display unit 210 of the external cover 200 will be described in detail in connection with FIGS. 3 to 9. In various embodiments of the present disclosure, for convenience of explanation, it may be assumed that the data to be outputted onto the display unit 210 of the external cover 200 refers to widgets, although not limited thereto.

In various embodiments of the present disclosure, a background screen for the external cover refers to an additional background screen for displaying widgets displayed in the display unit of the external cover, in addition to at least one background screen to display icons or widgets that represent a predetermined number of applications fixed in standby mode or selected by the user of the electronic device.

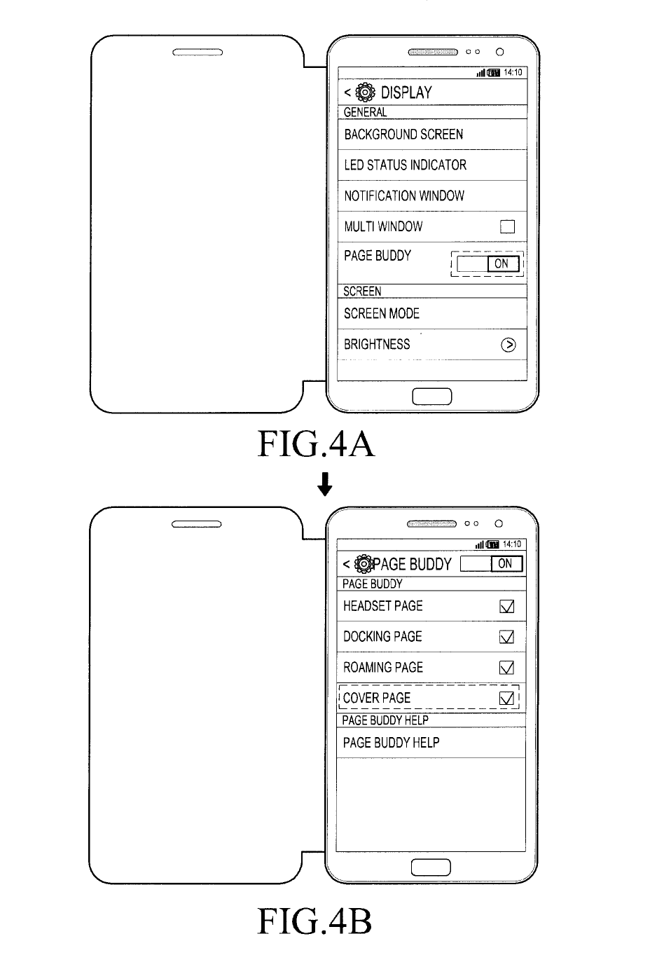

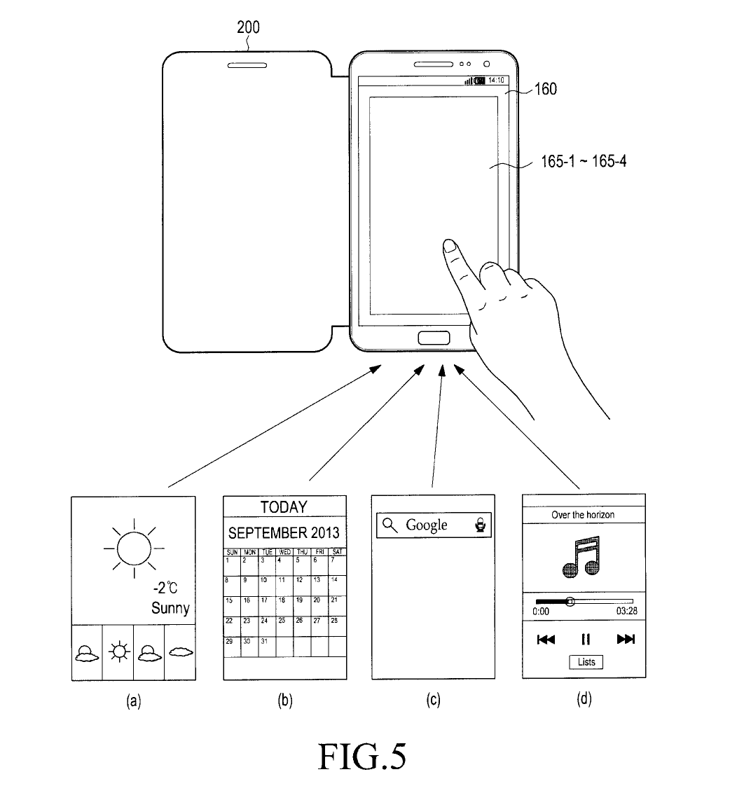

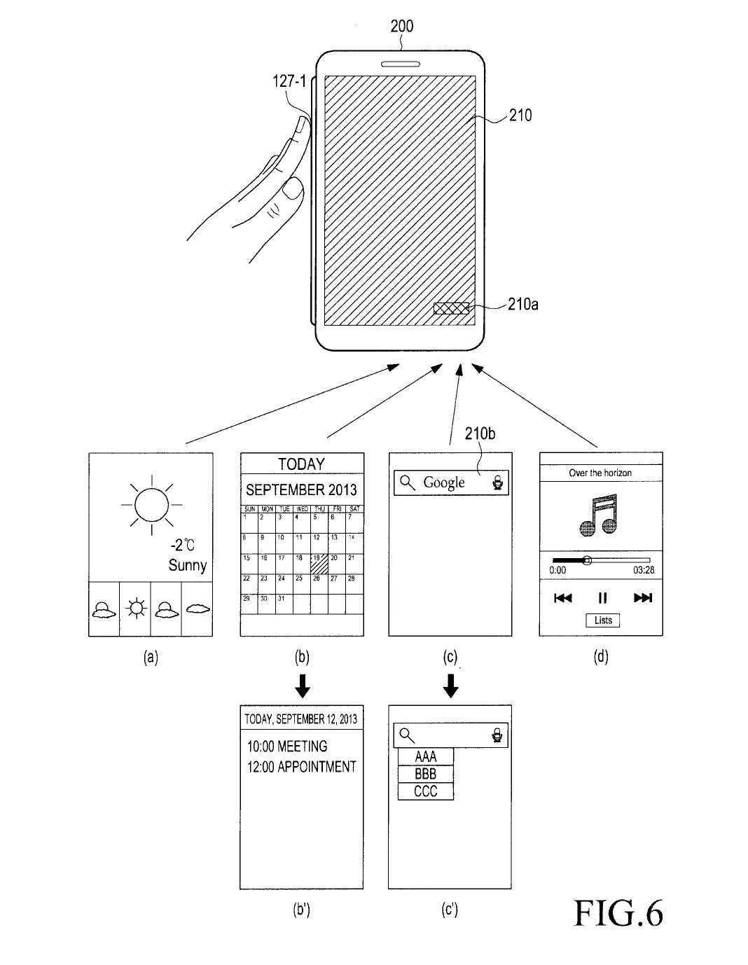

FIG. 3 is flowchart illustrating operations of data change for output from the electronic device 100 having the external cover 200 attached thereto to the display unit 210 of the external cover 200, FIGS. 4A and 4B illustrate the electronic device 100 setting a background screen for an external cover 200 attached to the electronic device 100 using the menu for settings, according to various embodiments of the present disclosure, FIG. 5 illustrates how to configure data of the electronic device 100 for output onto the display unit 210 of the external cover 200 attached to the electronic device 100, according to various embodiments of the present disclosure, and FIG. 6 illustrates how to output data of the electronic device 100 onto the display unit 210 of the external cover 200 attached to the electronic device 100 while the external cover 200 is closed, according to various embodiments of the present disclosure.

Embodiments of FIGS. 3 to 6 will be described in conjunction with FIGS. 1 and 2.

Referring to FIG. 3, in operation 301, the controller 110 may determine from the external cover attachment/detachment detector 180 whether the external cover 200 is attached to the electronic device 100. If it is determined that the external cover 200 is attached to the electronic device 100, the controller 110 may determine whether a background screen for external cover is set in the electronic device 100, in operation 303.

In various embodiments of the present disclosure, the background screen for external cover refers to a separate background screen for external cover in which data to be outputted to the display unit 210 of the external cover 200 is configured.

Operation of the electronic device 100 setting the background screen for external cover will now be described in connection with FIGS. 4A and 4B.

When “page buddy” is selected in the menu for display settings, as shown in FIG. 4A, the page buddy menu is displayed as shown in FIG. 4B. When “cover page” is selected in the page buddy menu, the background screen for external cover may be set in the electronic device 100.

As such, with the background screen for external cover set in the electronic device 100 by selection of “cover page” in the menu for settings, the controller 110 may determine in operation 303 that the background screen for external cover is set and determine in operation 305 whether the external cover 200 is opened or closed.

Upon reception of a signal indicating that the external cover 200 is opened from the external cover open/close detector 170, the controller 10 may determine in operation 305 that the external cover 200 is opened, and may create and display a separate background screen for external cover on the display unit 160 of the electronic device 100, in operation 307.

While the separate background screen for external cover is displayed on the display unit 160, the controller 110 determines whether a widget is selected for a particular application among multiple applications stored in the electronic device 100, in operation 309. If the controller 110 determines that a widget is selected for a particular application, the controller 110 may change the first information of the selected widget, i.e., color information, to the second information for display on the display unit 210 of the external cover 200, in operation 311.

For example, if the display unit 210 of the external cover 200 is the EPD panel that supports mono-color, the controller 110 may change the color of the widget to a black and white color.

The first and second information may also include size information. In this case, when the controller 110 changes the first information of the widget to the second information in operation 311, it may change the color and size of the widget to those for display on the display unit 210 of the external cover 200.

While displaying the background screen for external cover on the display unit 160, the controller 110 may provide a recommended widget by displaying at least a widget for at least one application determined to be appropriate for display on the display unit 210 of the external cover 200 among the plurality of applications as the recommended widget. For example, the controller 110 may display a widget for a weather application, a widget for a scheduler application, etc. as the recommended widget to be configured for the background screen for external cover.

In operation 311, the controller 110 may configure and display a widget with the second information for the background screen for external cover.

If creation of an additional background screen for external cover is selected in operation 313, the controller 110 may repeat operations 307 to 311 to create multiple background screens for external cover and to configure and display respective widgets with the second information for the multiple background screens for external cover.

In various embodiments of the present disclosure, the number of the multiple background screens for external cover may be the same as the number of background screens created in the electronic device 100, in which case, when it is determined that the background screen for external cover is set, a same number of background screens for external cover as the number of background screens created in the electronic device 100 may be automatically created.

Upon reception of a signal indicating that the external cover 200 is closed from the external cover open/close detector 170 after at least one background screen for external cover has been created by repeatedly performing operations 307 to 313, the controller 110 may determine that the external cover 200 is closed in operation 315, and may transmit power and the widget with the second information configured for a particular background screen for external cover among the at least one background screen for external cover to the display unit 210 of the external cover 200 in operation 317.

In various embodiments of the present disclosure, the particular background screen for external cover may be the background screen once displayed on the display unit 160 of the electronic device 100 when the external cover 200 is closed, or may be the first one of the multiple background screens for external cover.

While displaying the widget on the display unit 210 of the external cover 200 by outputting the widget with the second information configured for the particular background screen for external cover onto the display unit 210 of the external cover 200, upon determination that a particular key is pressed in operation 319, the controller 110 may output a widget configured for the next background screen for external cover to the background screen for external cover in which a current widget is displayed onto the display unit 210 of the external cover 200, in operation 321. In various embodiments of the present disclosure, the particular key refers to a key available while the external cover 200 is closed, which may be e.g., a volume key formed on the side of the electronic device 100 or a soft key that is displayed on the display unit 210 of the external cover 200.

Through operations 319 to 321, the user may display a desired widget on the display unit 210 of the external cover 200 by searching widgets configured for the multiple background screens for external cover while the external cover 200 is closed.

The display unit 210 of the external cover 200 continues to display a particular widget, but may be refreshed after the lapse of a particular period of time (e.g., 1 minutes) or when an event (e.g., message reception, incoming calls, song file changes, etc.) occurs.

An example of the embodiment of FIG. 3 will be described in conjunction with FIGS. 5 and 6.

Referring to FIG. 5, if a background screen for external cover is set in the electronic device 100, a separate first background screen 165-1 may be created on the display unit 160.

For example, if widget (a) for a weather application is selected from among widgets (a) to (n) for multiple applications stored in the electronic device 100 for the first background screen 165-1, first information of the widget (a) indicating e.g., colors or first size of the widget (a) may be changed to second information indicating e.g., black and white color or second size for display on the display unit 210 of the external cover 200 and the widget (a) may be set and displayed for the first background screen 165-1 for external cover.

As the user selects to create an additional background screen for external cover, second background screen 165-2 for external cover may be created. If widget (b) for a scheduler application is selected from among widgets (a) to (n) for multiple applications stored in the electronic device 100 for the second background screen 165-2, first information of the widget (b) indicating e.g., colors or first size of the widget (b) may be changed to second information indicating e.g., black and white color or second size for display on the display unit 210 of the external cover 200 and the widget (b) may be set and displayed for the second background screen 165-2 for external cover.

As the user selects to create another additional background screen for external cover, third background screen 165-3 for external cover may be created. If widget (c) for a search application is selected from among widgets (a) to (n) for multiple applications stored in the electronic device 100 for the third background screen 165-3, first information of the widget (c) indicating e.g., colors or first size of the widget (c) may be changed to second information indicating e.g., black and white color or second size for display on the display unit 210 of the external cover 200 and the widget (c) may be set and displayed for the third background screen 165-3 for external cover.

As the user selects to create another additional background screen for external cover, fourth background screen 165-4 for external cover may be created. If widget (d) for a song application is selected from among widgets (a) to (n) for multiple applications stored in the electronic device 100 for the fourth background screen 165-4, first information of the widget (d) indicating e.g., colors or first size of the widget (c) may be changed to second information indicating e.g., black and white color or second size for display on the display unit 210 of the external cover 200 and the widget (d) may be set and displayed for the fourth background screen 165-4 for external cover.

After completion of creating widgets for the display unit 210 of the external cover 200 as shown in FIG. 5, when the external cover 200 is closed as shown in FIG. 5, the display unit 210 may display the weather widget (a) with the second information, e.g., the weather widget (a) represented in the black and white color or in a size corresponding to the display unit 210.

If a particular key, e.g., a volume key 127-1 is pressed, the scheduler widget (b), the search widget (c), and the song widget (d) may be sequentially displayed on the display unit 210 of the external cover 200 in response to inputs of the volume key 127-1.

Alternatively, while the weather widget (a) is displayed on the display unit 210, a soft key 210a may be emerged in a part, e.g., a lower corner, of the display unit 210. If the soft key 210a is pressed, the scheduler widget (b), the search widget (c), and the song widget (d) may be sequentially displayed on the display unit 210 of the external cover 200 in response to touch inputs of the soft key 210a.

At least one soft key may be displayed on the display unit 210 while the external cover 200 is closed, and the at least one soft key may have different functions depending on the types of widgets.

If a date is touched while the scheduler widget (b) is displayed on the display unit 210 of the external cover 200 closed over the electronic device 100, the controller 110 may change first information of scheduled data stored for the date to second information for display on the display unit 210 and display the scheduled data (b′) based on the second information on the display unit 210.

If a search window 210b is touched while the search widget (c) is displayed on the display unit 210 of the external cover 200 closed over the electronic device 100, the controller 110 may change first information of a history list to second information for display on the display unit 210 and display the history list (c′) based on the second information on the display unit 210.

If a current song has just finished and the next song begins to be played while the song widget (d) is displayed on the display unit 210 of the external cover 200 closed over the electronic device 100, the controller 110 may change first information of a description (e.g., title, artist, etc.) of the next song to second information for display on the display unit 210 and refresh the display unit 210 by displaying the description of the next song based on the second information.

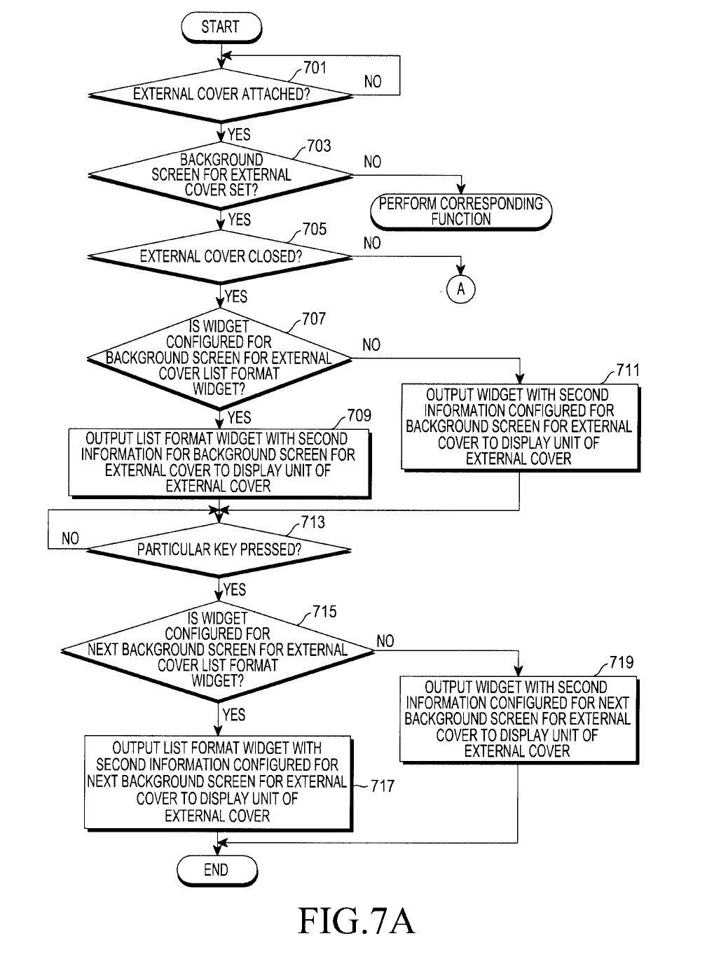

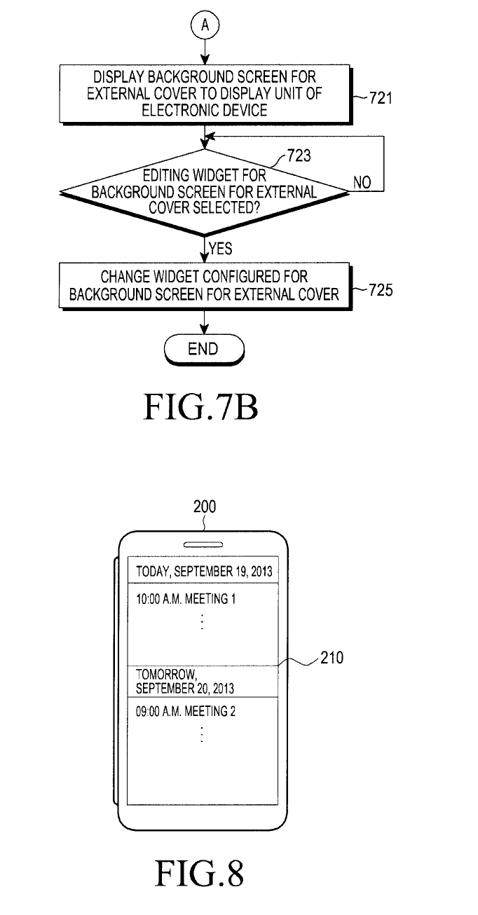

FIGS. 7A and 7B illustrate flowchart of operations of outputting data onto the display unit 210 of the external cover 200 by changing the data to list data while the external cover 200 attached to the electronic device 100 is closed over the electronic device 100, according to various embodiments of the present disclosure, and FIG. 8 illustrates an electronic device outputting data onto the display unit 210 of the external cover 200 attached to the electronic device 100 by changing the data to list data while the external cover 200 is closed over the electronic device 100, according to various embodiments of the present disclosure. Embodiments of FIGS. 7 and 8 will be described in conjunction with FIGS. 1 and 2.

Referring to FIGS. 7A and 7B, in operation 701, the controller 110 may determine from the external cover attachment/detachment detector 180 whether the external cover 200 is attached to the electronic device 100. If it is determined that the external cover 200 is attached to the electronic device 100, in operation 703, the controller 110 may determine whether a background screen for external cover is set in the electronic device 100.

Upon reception of a signal indicating that the external cover 200 is closed from the external cover open/close detector 170, the controller 10 may determine that the external cover 200 is closed in operation 705, and may determine whether a widget configured for a particular background screen for external cover among various background screens for external cover is possible to be displayed in a list format, in operation 707. If it is determined in operation 707 that the widget configured in the particular background screen for external cover may be displayed in a list format, the controller 110 may detect a list format widget corresponding to the widget configured in the particular background screen for external cover, change first information of the list format widget to second information for display on the display unit 210 of the external cover 200, and transmit power and the list display widget with the second information to the display unit 210 through the external cover connector 190, in operation 709.

Otherwise, if it is determined in operation 707 that the widget configured for the particular background screen for external cover may not be displayed in a list format, the controller 110 may transmit power and the widget with the second information to the display unit 210 through the external cover connector 190, in operation 711.

In various embodiments of the present disclosure, the particular background screen for external cover may be the background screen once displayed on the display unit 160 of the electronic device 100 when the external cover 200 is closed, or may be the first one of the multiple background screens for external cover.

If it is determined in operation 713 that a particular key has been pressed while the list format widget or the widget with the second information is displayed on the display unit 210 of the external cover 200, the controller 110 may determine whether a widget configured for the next background screen for external cover may be displayed in the list format if there are multiple background screens for external cover, in operation 715. If it is determined in operation 715 that the widget configured for the next background screen for external cover may be displayed in a list format, the controller 110 may detect a list format widget corresponding to the widget configured for the next background screen for external cover, change first information of the list format widget to second information for display on the display unit 210 of the external cover 200, and transmit power and the list display widget with the second information to the display unit 210 through the external cover connector 190, in operation 717.

Otherwise, if it is determined in operation 715 that the widget configured for the next background screen for external cover may not be displayed in a list format, the controller 110 may transmit power and the widget with the second information to the display unit 210 through the external cover connector 190, in operation 719. In various embodiments of the present disclosure, the particular key refers to a key available while the external cover 200 is closed, which may be e.g., a volume key formed on the side of the electronic device 100 or a soft key that is displayed on the display unit 210 of the external cover 200.

By performing operations 713 to 719, the user may display a desired widget on the display unit 210 of the external cover 200 by searching widgets configured for the multiple background screens for external cover while the external cover 200 is closed.

If the controller 110 receives a signal indicating that the external cover 200 is opened, after determining in operation 703 that a background screen for external cover is set or while displaying the widget or the list format widget with the second information on the display unit 210 of the external cover 200, the controller 110 may determine that the external cover 200 is opened and display the background screen for external cover for which a widget is configured with the second information on the display unit 160 of the electronic device 100, in operation 721.

If the controller 110 determines in operation 723 that the user selects to edit the widget while the background screen for external cover is displayed on the display unit 160, the controller 110 may switch the electronic device 100 into a widget editing mode. In the widget editing mode, the user may select a new widget, and the controller 110 may then change first information of the new widget to second information for display on the display unit 210 of the external cover 200, assign the new widget with the second information to the background screen for external cover, and display the new widget on the display unit 160 of the electronic device 100, in operation 725.

An example of the embodiment of FIGS. 7A and 7B will be described in conjunction with FIG. 8.

First, if the weather widget (a), the scheduler widget (b), the search widget (c), and the song widget (d) are configured for first to fourth background screens 165-1, 165-2, 165-3, and 165-4, respectively, as shown in FIG. 5, the weather widget (a) configured for the first background screen 165-1 may be displayed on the display unit 210 of the external cover 200 when the external cover 200 is closed. Then, if a particular key equipped in the electronic device 100 is pressed or a soft key displayed on the display unit 210 is touched, causing the scheduler widget (b) configured for the second background screen 165-2 for external cover to be displayed on the display unit 210, the scheduler widget (b) that may be displayed in a list format may be outputted and displayed as a list format widget, as shown in FIG. 8.

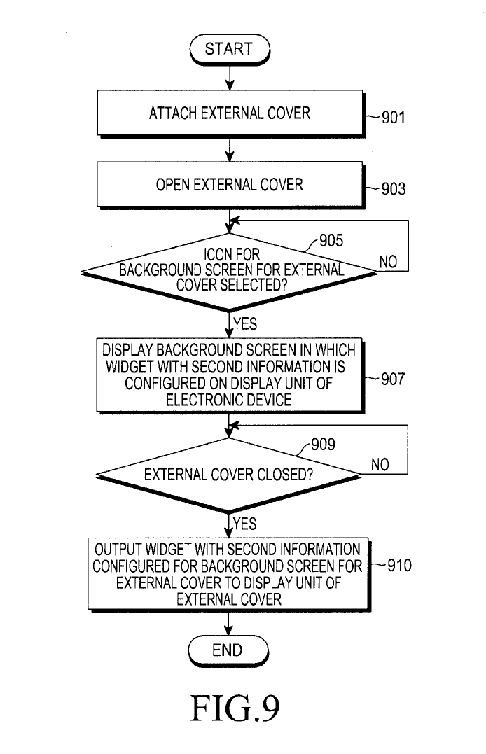

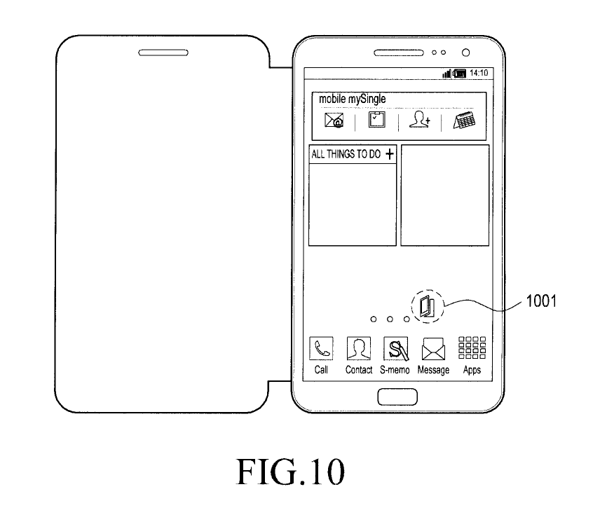

FIG. 9 is flowchart illustrating operations of outputting data of an electronic device having an external cover attached thereto onto a display unit of the external cover by selecting a background screen UI for external cover, according to various embodiments of the present disclosure, and FIG. 10 illustrates an electronic device providing a background screen UI for an external cover attached to the electronic device, according to various embodiments of the present disclosure.

Embodiments of FIGS. 9 and 10 will be described in conjunction with FIGS. 1 and 2.

Referring to FIG. 9, in operation 901, the controller 110 may determine that the external cover 200 is attached to the electronic device 100 upon reception of a signal indicating that the external cover 200 is attached to the electronic device 110 from the external cover attachment/detachment detector 180. In operation 903, the controller 110 may determine that the external cover is opened upon reception of a signal indicating that the external cover is closed over the electronic device 100 from the external cover open/close detector 170. With the external cover opened, multiple UIs for multiple applications, e.g., icons may be displayed on the display unit 160 of the electronic device 100. In operation 905, the controller 110 determines whether an icon for background screen for external cover is selected from among multiple icons for multiple applications. If it is determined that the icon for background screen for external cover is selected, the controller 110 displays a separate background screen for external cover in which a widget with the second information is configured on the display unit 160 of the electronic device 100, in operation 907.

FIG. 10 shows an icon 1001 for background screen for external cover. In FIG. 10, the icon 1001 for background screen for external cover may be emerged when there is any background screen for external cover in which a widget with the second information is configured. When the icon 1001 for background screen for external cover is selected, a background screen for external cover may be set, as shown in FIGS. 4A and 4B.

While the background screen for external cover in which a widget with the second information is configured is displayed on the display unit 160 after selection of the icon 1001 for background screen for external cover, the controller 110 may determine whether the external cover 200 is closed, in operation 909. If the controller 110 determines that the external cover 200 is closed by receiving a signal indicating that the external cover 200 is closed from the external cover open/close detector 170, the controller 110 may transmit power and output the widget with the second information configured for the background screen for external cover onto the display unit 210, in operation 910.

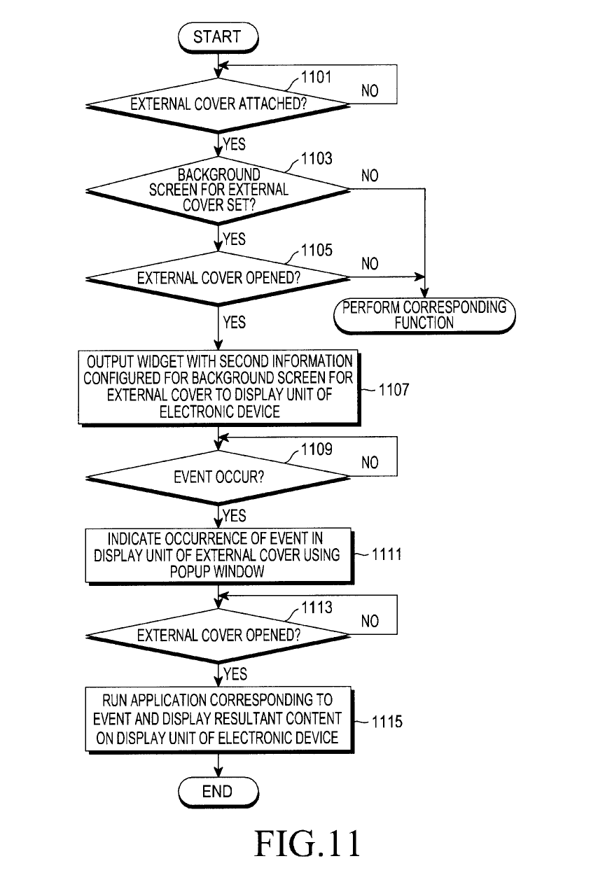

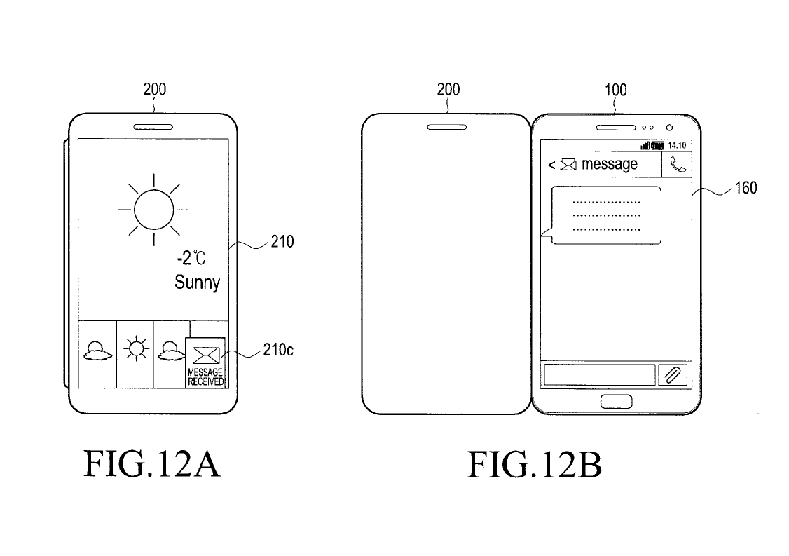

FIG. 11 is flowchart illustrating operations of handling an event that occurs while an external cover attached to an electronic device is closed over the electronic device, according to various embodiments of the present disclosure, and FIG. 12 illustrates an electronic device handling an event that occurs while an external cover attached to the electronic device is closed over the electronic device, according to various embodiments of the present disclosure.

Embodiments of FIGS. 11 and 12 will be described in conjunction with FIGS. 1 and 2.

Referring to FIG. 11, in operation 1101, the controller 110 may determine from the external cover attachment/detachment detector 180 whether the external cover 200 is attached to the electronic device 100. If it is determined that the external cover 200 is attached to the electronic device 100, in operation 1103, the controller 110 may determine whether a background screen for external cover is set in the electronic device 100.

Upon reception of a signal indicating that the external cover 200 is closed from the external cover open/close detector 170 after at least one background screen for external cover has been created, the controller 110 may determine that the external cover 200 is closed in operation 1105, and transmit power and the widget with the second information configured for a particular background screen for external cover among the at least one background screen for external cover to the display unit 210 of the external cover 200 in operation 1107.

If the controller 110 determines that an event occurs in operation 1109 while outputting the widget with the second information onto the display unit 210 of the external cover 200, the controller 110 may perform operation of indicating the occurrence of the event, e.g., by means of a pop-up window, in operation 1111.

Upon reception of a signal indicating that the external cover 200 is opened from the external cover open/close detector 170, the controller 110 may determine that the external cover 200 is opened, in operation 1113, and may run an application corresponding to the event and display the resultant content on the display unit 160 of the electronic device 100 in operation 1115.

An example of the embodiment of FIG. 11 will be described in connection with FIG. 12.

As shown in FIG. 12A, if an event of message reception occurs while the weather widget (a) is outputted on the display unit 210 of the external cover 200 closed over the electronic device 100, the controller 110 may indicate the event of message reception by opening a pop-up window 210c in a bottom right corner of the display unit 210, notifying that a message has been received.

If the controller 110 determines that the external cover 200 is opened while indicating the event of message reception by means of the pop-up window on the display unit 210, the controller 110 runs a message application and display the received message content on the display unit 160 of the electronic device 200, as shown in FIG. 12B.

According to various embodiments of the present disclosure, an electronic device and method for outputting data in the electronic device may output data of the electronic device, which is optimized for a display unit of an external cover attached to the electronic device, onto the display unit. Furthermore, displaying various applications of the electronic device onto the display unit of the external cover may increase the applications' utilization.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

What is claimed is:

1. An electronic device, comprising:
an external cover connector connected to a display unit of an external cover; and
a controller configured to change first information of data selected to be displayed on the display unit of the external cover to second information for the display unit of the external cover; and output the data with the second information to the display unit of the external cover while the external cover attached to the electronic device is closed over the electronic device.

2. The electronic device of claim 1, wherein if the external cover is opened, the controller is configured to create and display at least one background screen for external cover on a display unit of the electronic device; change first information of at least one data selected to be displayed on the display unit of the external cover to second information; and configure and display the at least one data with the second information for the at least one background screen.

3. The electronic device of claim 2, wherein upon detection of attachment of the external cover to the electronic device, the controller is configured to determine whether a background screen for external cover is set, and if the external cover is opened when it is determined that the background screen for external cover is set, create and display the at least one background screen for external cover on the display unit of the electronic device.

4. The electronic device of claim 2, wherein the controller is configured to create and display at least one background screen for external cover on the display unit of the electronic device, and display at least one of recommended data determined to be appropriate for display on the display unit of the external cover.

5. The electronic device of claim 2, wherein the first information comprises color information for display on the display unit of the electronic device, and the second information comprises color information for display on the display unit of the external cover.

6. The electronic device of claim 2, wherein if the external cover is closed, the controller is configured to output a particular data among at least one data with the second information, which are configured for the at least one background screen for external cover, to the display unit of the external cover, and if a particular key is pressed while the external cover is closed, output at least one data with the second information, which are configured for the at least one background screen for external cover, to the display unit of the external cover sequentially.

7. The electronic device of claim 1, wherein if the external cover attached to the electronic device is closed and it is determined that data configured for a particular background screen for external cover among at least one background screen for external cover is list format data that is possibly displayed in a list format, the controller is configured to output the list format data to the display unit of the external cover.

8. The electronic device of claim 7, wherein if the external cover is opened, the controller is configured to display the background screen for external cover in which data with the second information is configured, on the display unit of the electronic device, and configure new data by changing the data with the second information to the new data with the second information.

9. The electronic device of claim 1, wherein if a background screen User Interface (UI) for external cover is selected in a display unit of the electronic device having the external cover attached thereto,
the controller is configured to display the background screen for external cover in which data with the second information is configured, on the display unit of the electronic device, and if the external cover is closed, display the data with second information that is configured for the background screen for external cover on the display unit of the external cover, and if a particular key is pressed while the external cover is closed, output at least one data with the second information, which are configured for the at least one background screen for external cover, to the display unit of the external cover sequentially.

10. The electronic device of claim 1, wherein the controller is configured to indicate an event that occurs while data with the second information is displayed on the display unit of the external cover that is closed over the electronic device, and if the external cover is opened, run an application that corresponds to the event and display the resultant content on the display unit of the electronic device.

11. A method for outputting data in an electronic device, the method comprising:
changing first information of data selected to be displayed on a display unit of an external cover attached to the electronic device to second information for the display unit of the external cover; and
outputting data with the second information to the display unit of the external cover if the external cover is closed over the electronic device.

12. The method of claim 11, wherein changing first information of data selected to be displayed on a display unit of an external cover attached to the electronic device to second information for the display unit of the external cover comprises
creating and displaying a background screen for external cover on a display unit of the electronic device if the external cover is opened;
if data is selected while the background screen for external cover is displayed, changing the first information of the selected data to the second information, and configuring and displaying the data with the second information for the background screen for external cover;
if addition of a background screen for external cover is selected, creating and displaying a new background screen for external cover; and
if another data is selected while the new background screen for external cover is displayed, changing the first information of the selected data to the second information, and configuring and displaying the data with the second information for the new background screen for external cover.

13. The method of claim 12, wherein the displaying comprises
determining whether a background screen for external cover is set, upon detection of attachment of the external cover to the electronic device; and
creating and displaying a background screen for external cover on the display unit of the electronic device if it is determined that a background screen is set.

14. The method of claim 12, wherein the displaying comprises
displaying at least one recommended data determined to be appropriate for display on the display unit of the external cover after at least one background screen for external cover is created and displayed on the display unit of the electronic device.

15. The method of claim 11, wherein the first information comprises color information for display on the display unit of the electronic device, and the second information comprises color information for display on the display unit of the external cover.

16. The method of claim 11, wherein the outputting comprises
outputting a particular data among at least one data with the second information, which are configured for the at least one background screen for external cover, to the display unit of the external cover, if the external cover is closed; and
if a particular key is pressed while the external cover is closed, outputting at least one data with the second information, which are configured for the at least one background screen for external cover, to the display unit of the external cover sequentially.

17. The method of claim 11, further comprising:
determining whether a background screen for external cover is set, upon detection of attachment of the external cover to the electronic device;
if it is determined that the background screen for external cover is set and the external cover is closed over the electronic device, determining whether data configured for a particular background screen for external cover among at least one background screen for external cover is list format data that is possibly displayed in a list format; and
if it is determined that the data configured for the particular background screen for external cover is the list format data, outputting the list format data to the display unit of the external cover.

18. The method of claim 17, further comprising:
if the external cover is opened, displaying the background screen for external cover in which data with the second information is configured, on the display unit of the electronic device, and
if data editing is selected, configuring new data by changing the data with the second information to the new data with the second information.

19. The method of claim 11, further comprising:
if a background screen User Interface (UI) for external cover is selected in a display unit of the electronic device having the external cover attached thereto, displaying the background screen for external cover in which data with the second information is configured, on the display unit of the electronic device, and
if the external cover is closed, displaying the data with second information that is configured for the background screen for external cover on the display unit of the external cover, and
if a particular key is pressed while the external cover is closed, outputting at least one data with the second information, which are configured for the at least one background screen for external cover, to the display unit of the external cover sequentially.

20. The method of claim 11, further comprising:
if an event occurs while data with the second information is displayed on the display unit of the external cover that is closed over the electronic device, indicating the event on the display unit of the external cover; and
if the external cover is opened while the event is indicated on the display unit of the external cover, running an application corresponding to the event and displaying the resultant content on a display unit of the electronic device.
